(19) United States
(12) Patent Application Publication
(10) Pub. No.: US 2023/0059783 A1
(43) Pub. Date: Feb. 23, 2023

(54) Method for Producing Organosilicon Compound Having Ketimine Structure

(71) Applicant: Shin-Etsu Chemical Co., Ltd., Tokyo (JP)

(72) Inventors: Shigeki YASUDA, Annaka-shi (JP); Munenao HIROKAMI, Annaka-shi (JP)

(73) Assignee: Shin-Etsu Chemical Co., Ltd., Tokyo (JP)

(21) Appl. No.: 17/864,096

(22) Filed: Jul. 13, 2022

(30) Foreign Application Priority Data
Aug. 4, 2021 (JP) 2021-128006

(51) Int. Cl. C07F 7/18

(52) U.S. Cl. CPC C07F 7/1892

(57) ABSTRACT

A method for producing an organosilicon compound having the formula (1) and having a ketimine structure, the method including reacting an amino group-containing organosilicon compound having the formula (2) and having a chlorine atom content of less than 0.1 ppm by weight with a carbonyl compound having the formula (3).

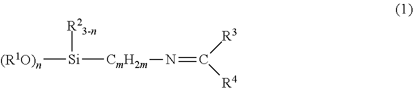

R¹ independently represents an alkyl group having 1 to 10 carbon atoms or an aryl group having 6 to 10 carbon atoms, R² independently represents an alkyl group having 1 to 10 carbon atoms or an aryl group having 6 to 10 carbon atoms, R³ and R⁴ each independently represent a hydrogen atom, an alkyl group having 1 to 10 carbon atoms, or an aryl group having 6 to 10 carbon atoms, n represents an integer of 1 to 3, and m represents an integer of 1 to 12.

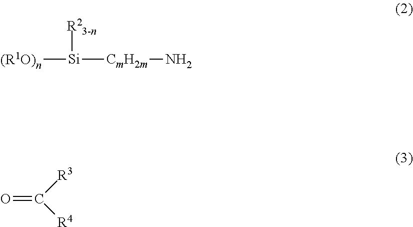

R¹, R², R³, R⁴, n, and m are as described above.

### CROSS-REFERENCE TO RELATED APPLICATION

This non-provisional application claims priority under 35 U.S.C. § 119(a) on Patent Application No. 2021-128006 filed in Japan on Aug. 4, 2021, the entire contents of which are hereby incorporated by reference.

### TECHNICAL FIELD

The present invention relates to a method for producing an organosilicon compound having a ketimine structure.

### BACKGROUND ART

Silane coupling agents are compounds having a portion having reactivity with an inorganic substance (a hydrolyzable group bonded to a Si atom) and a portion having high reactivity and high solubility with an organic substance in one molecule, and are widely used as a resin modifier.

Among them, silane coupling agents having a ketimine structure have been studied as a modifier of a conjugated diene copolymer (Patent Document 1).

However, the organosilicon compounds having a ketimine structure have such poor storage stability that an organosilicon compound having an active hydrogen group is generated over time, resulting in possibility of adverse effect on the mixed composition.

Patent Document 2 discloses a production method in which an amino group-containing organosilicon compound is reacted with a carbonyl compound to obtain a silane coupling agent having a ketimine structure and then the chlorine atom content is reduced with an inorganic adsorbent to improve the storage stability. However, the production method has a problem in productivity, for example, that a decrease in filterability and an increase in waste are caused at the time of removing the inorganic adsorbent because the inorganic adsorbent is used in a large amount in the step of removing chlorine atoms from the silane coupling agent having a ketimine structure.

### CITATION LIST

Patent Document 1: JP-A H 11-349632
Patent Document 2: JP-A 2019-194161

### SUMMARY OF THE INVENTION

The present invention has been made in view of the above circumstances, and an object of the present invention is to provide a method for producing an organosilicon compound having a ketimine structure and excellent in storage stability, with excellent productivity.

As a result of intensive studies to solve the above problems, the present inventors have found that an organosilicon compound having a ketimine structure and having high storage stability can be produced by reacting an amino group-containing organosilicon compound having a chlorine atom content of less than 0.1 ppm by weight, and have completed the present invention.

That is, the present invention provides the following items:

1. A method for producing an organosilicon compound having a ketimine structure, the organosilicon compound having the formula (1) described below:

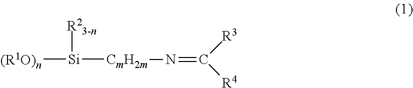

wherein each R¹ independently represents an alkyl group having 1 to 10 carbon atoms or an aryl group having 6 to 10 carbon atoms,

each R² independently represents an alkyl group having 1 to 10 carbon atoms or an aryl group having 6 to 10 carbon atoms,

R³ and R⁴ each independently represent a hydrogen atom, an alkyl group having 1 to 10 carbon atoms, or an aryl group having 6 to 10 carbon atoms,

n represents an integer of 1 to 3, and m represents an integer of 1 to 12,

the method including a step of reacting an amino group-containing organosilicon compound having the formula (2) described below and having a chlorine atom content of less than 0.1 ppm by weight with a carbonyl compound having the formula (3) described below:

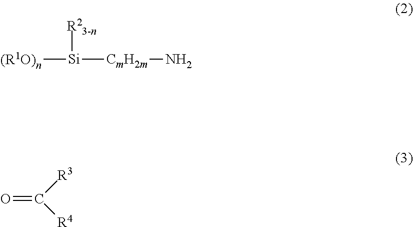

wherein R¹, R², R³, R⁴, n, and m are as described above;

2. The method for producing an organosilicon compound having a ketimine structure according to 1, wherein R¹ is a methyl group or an ethyl group, R³ is an isobutyl group, R⁴ is a methyl group, and m and n are 3;

3. The method for producing an organosilicon compound having a ketimine structure according to 1 or 2, including a step of reducing a chlorine atom content of the amino group-containing organosilicon compound having the formula (2) to less than 0.1 ppm by weight using an inorganic adsorbent;

4. A method for producing an amino group-containing organosilicon compound, the amino group-containing organosilicon compound having the formula (2) described below:

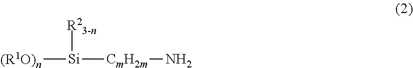

wherein each R¹ independently represents an alkyl group having 1 to 10 carbon atoms or an aryl group having 6 to 10 carbon atoms,

each R² independently represents an alkyl group having 1 to 10 carbon atoms or an aryl group having 6 to 10 carbon atoms,

n represents an integer of 1 to 3, and m represents an integer of 1 to 12,

the method including a step of reducing a chlorine atom content to less than 0.1 ppm by weight using an inorganic adsorbent; and

5. The method for producing an amino group-containing organosilicon compound according to 4, wherein the inorganic adsorbent is one or more selected from silica, aluminum hydroxide, hydrotalcite, magnesium silicate, aluminum silicate, aluminum oxide, and magnesium oxide.

### Advantageous Effects of the Invention

According to the method for producing of the present invention, the amount of the inorganic adsorbent used can be reduced, and an organosilicon compound having a ketimine structure and excellent in storage stability can be obtained.

### DESCRIPTION OF THE PREFERRED EMBODIMENT

Hereinafter, the present invention is specifically described.

The method for producing an organosilicon compound having a ketimine structure according to the present invention is a method for producing an organosilicon compound having the formula (1) described below, and includes a step of reacting an amino group-containing organosilicon compound having the formula (2) described below and having a chlorine atom content of less than 0.1 ppm by weight with a carbonyl compound having the formula (3) described below.

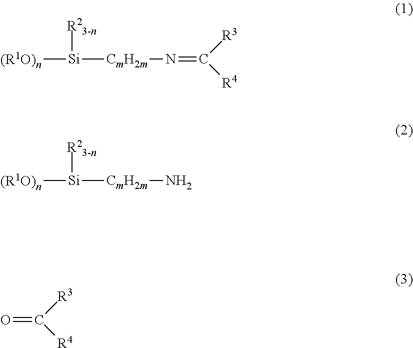

In each of the above formulae, each R¹ independently represents an alkyl group having 1 to 10 carbon atoms or an aryl group having 6 to 10 carbon atoms, each R² independently represents an alkyl group having 1 to 10 carbon atoms or an aryl group having 6 to 10 carbon atoms, and R³ and R⁴ each independently represent a hydrogen atom, an alkyl group having 1 to 10 carbon atoms, or an aryl group having 6 to 10 carbon atoms.

The alkyl group having 1 to 10 carbon atoms may be linear, cyclic, or branched, and specific examples of the alkyl group include methyl, ethyl, n-propyl, i-propyl, n-butyl, isobutyl, s-butyl, t-butyl, n-pentyl, neopentyl, n-hexyl, n-heptyl, n-octyl, n-nonyl, n-decyl, cyclopropyl, cyclobutyl, cyclopentyl, cyclohexyl, cycloheptyl, and cyclooctyl groups.

Specific examples of the aryl group having 6 to 10 carbon atoms include phenyl, α-naphthyl, and β-naphthyl groups.

Among the groups, linear alkyl groups are preferable as R¹ and R², and a methyl group and an ethyl group are more preferable.

As R³ and R⁴, a hydrogen atom and an alkyl group having 1 to 6 carbon atoms are preferable, methyl, ethyl, n-propyl, n-butyl, and isobutyl groups are more preferable, methyl and isobutyl groups are still more preferable, and a combination of a methyl group and an isobutyl group is still even more preferable.

n represents an integer of 1 to 3, preferably 2 or 3, and more preferably 3.

m represents an integer of 1 to 12, preferably 2 or 3, and more preferably 3.

In the present invention, an organosilicon compound having the following formula (4) or (5) is particularly preferable.

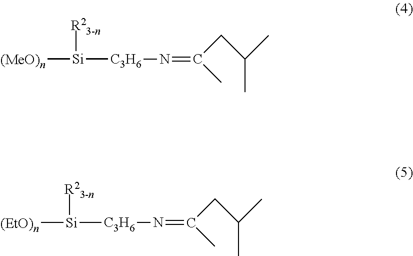

In the formulae, R² and n are as described above, Me is a methyl group, and Et is an ethyl group.

In the present invention, an organosilicon compound having a ketimine structure and having good storage stability can be obtained by using the amino group-containing organosilicon compound having the formula (2) and having a chlorine atom content of less than 0.1 ppm by weight.

If the amino group-containing organosilicon compound having the formula (2) and having a chlorine atom content of less than 0.1 ppm by weight is not used, the organosilicon compound having a ketimine structure and having the formula (1) has poor storage stability. Specifically, in the case of the organosilicon compound having the formula (7), the organosilicon compounds having the formulae (8) to (11) are generated over time.

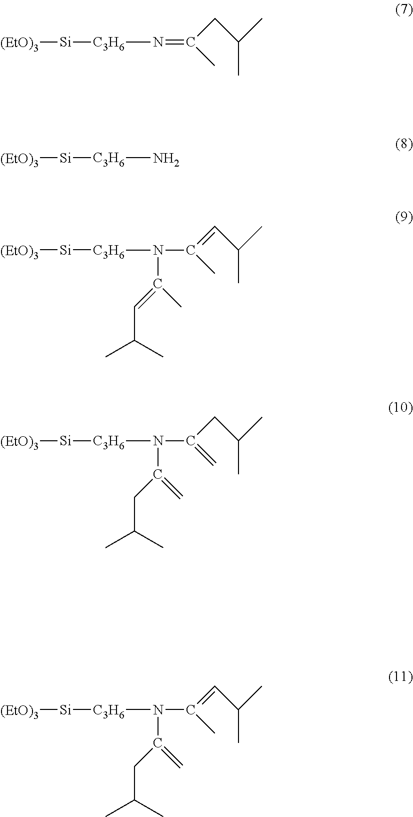

Specific examples of the amino group-containing organosilicon compound having the formula (2) include 3-aminopropyltrimethoxysilane, 3-aminopropyldimethoxymethylsilane, and 3-aminopropyltriethoxysilane.

Meanwhile, specific examples of the carbonyl compound having the formula (3) include dimethyl ketone, methyl ethyl ketone, methyl isobutyl ketone, acetaldehyde, benzaldehyde, and propionaldehyde.

During the reaction, the reaction between the amino group-containing organosilicon compound and the carbonyl compound is preferably performed under a condition that the carbonyl compound is excessive in terms of molar ratio.

Although this reaction proceeds without a solvent, a solvent can be used. Specific examples of the usable solvent include hydrocarbon-based solvents such as pentane, hexane, cyclohexane, heptane, isooctane, benzene, toluene, and xylene. These solvents may be used singly or in combination of two or more kinds thereof, and among them, toluene is preferable.

During the reaction, water generated by the reaction between the amino group-containing organosilicon compound and the carbonyl compound is to be removed from the reaction system.

The method of removing water is not particularly limited, and a method is preferable in which a carbonyl compound or a solvent excessively present in the system is refluxed using a Dean-Stark apparatus or the like, and thus distilled off.

The reaction temperature is not particularly limited as long as water can be distilled off, and is preferably 100 to 200° C.

The amino group-containing organosilicon compound, used in the present invention, that has the formula (2) and has a chlorine atom content of less than 0.1 ppm by weight can be obtained by mixing an inorganic adsorbent and the amino group-containing organosilicon compound having the formula (2).

Examples of the inorganic adsorbent that can be suitably used for reducing the chlorine atom content include silica, aluminum hydroxide, hydrotalcite, magnesium silicate, aluminum silicate, aluminum oxide, magnesium oxide, and aluminum oxide-magnesium oxide solid solution, and these may be used singly or in combination of two or more kinds thereof.

These inorganic adsorbents can be obtained, for example, as commercially available KYOWAAD series (KYOWAAD 100, 200, 300, 500, 600, 700, and 2000) manufactured by Kyowa Chemical Industry Co., Ltd. Among them, KYOWAAD 500 (Mg₆Al₂(OH)₁₆CO₃·mH₂O), which is synthetic hydrotalcite, is particularly preferable from the viewpoint of treatment efficiency.

The amount of the inorganic adsorbent to be used is preferably 0.005 to 5.0 parts by weight, more preferably 0.01 to 0.2 parts by weight, and still more preferably 0.01 to 0.1 parts by weight per 100 parts by weight of the organosilicon compound having the formula (2) in consideration of enhancing the treatment efficiency and facilitating removal of the inorganic adsorbent after the treatment.

Furthermore, after mixed with the inorganic adsorbent, the amino group-containing organosilicon compound having the formula (2) is preferably purified by distillation.

By using the amino group-containing organosilicon compound having the formula (2) and having a chlorine atom content of less than 0.1 ppm by weight, a complicated step such as removal of the inorganic adsorbent can be omitted in the step of producing an organosilicon compound having a ketimine structure, and thus an organosilicon compound having a ketimine structure and excellent in storage stability can be easily produced.

### EXAMPLES

Hereinafter, the present invention is more specifically described with reference to Examples and Comparative Examples, but the present invention is not limited to these Examples.

The chlorine atom content was measured with the following method.

Chlorine Atom Content

The sample obtained in each of Examples and Comparative Examples or 10 g of 3-aminopropyltrimethoxysilane, 50 mL of toluene, and 20 mL of pure water were mixed and then stirred for 1 hour, the water layer was collected, and the water-soluble chloride ion concentration was measured with an ion chromatograph under the following conditions and taken as the chlorine atom content.

Ion chromatograph: ICA-2000 manufactured by DKK-TOA CORPORATION
Separation column: TOA-DKK PCI-230
Guard column: TOA-DKK PCI-205G
Suppressor: chemical suppressor 6810690K
Detector: electrical conductivity detector
Eluent: 4 mmol/L Na₂CO₃, 2 mmol/L NaHCO₃
Amount of eluent: 0.9 mL/min
Amount of injection liquid: 100 μL
Inlet temperature: 250° C.
Detector temperature: 300° C.

### Carrier gas: He

Carrier gas flow rate: 3.0 mL/min

[1] Production of Amino Group-Containing Organosilicon Compound Having Chlorine Atom Content of Less Than 0.1 ppm by Weight

### (1) Production of Amino Group-Containing Organosilicon Compound (12)

### Example 1

(MeO)₃—Si—C₃H₆—NH₂ (12)

In a 1 L separable flask equipped with a stirrer, a reflux condenser, a dropping funnel, and a thermometer, 1000.0 g of 3-aminopropyltrimethoxysilane and 1.0 g of KYOWAAD 100 (manufactured by Kyowa Chemical Industry Co., Ltd., the same applies hereinafter) were put and stirred at room temperature for 6 hours under a nitrogen atmosphere. From the resulting solution, KYOWAAD 100 was removed by pressure filtration, and the obtained solution was purified by distillation under the conditions of 10 Torr and 75° C. to obtain 890 g of an amino group-containing organosilicon compound (12) as a colorless transparent liquid. The obtained colorless transparent liquid had a chlorine atom content of less than 0.1 ppm by weight.

### Example 2

An amino group-containing organosilicon compound having the formula (12) and having a chlorine atom content of less than 0.1 ppm by weight was produced in the same manner as in Example 1 except that in place of KYOWAAD 100, the same part by weight of KYOWAAD 200 was used.

### Example 3

An amino group-containing organosilicon compound having the formula (12) and having a chlorine atom content of less than 0.1 ppm by weight was produced in the same manner as in Example 1 except that in place of KYOWAAD 100, the same part by weight of KYOWAAD 300 was used.

### Example 4

An amino group-containing organosilicon compound having the formula (12) and having a chlorine atom content of less than 0.1 ppm by weight was produced in the same manner as in Example 1 except that in place of KYOWAAD 100, the same part by weight of KYOWAAD 500 was used.

### Example 5

An amino group-containing organosilicon compound having the formula (12) and having a chlorine atom content of less than 0.1 ppm by weight was produced in the same manner as in Example 1 except that in place of KYOWAAD 100, the same part by weight of KYOWAAD 600 was used.

### Example 6

An amino group-containing organosilicon compound having the formula (12) and having a chlorine atom content of less than 0.1 ppm by weight was produced in the same manner as in Example 1 except that in place of KYOWAAD 100, the same part by weight of KYOWAAD 700 was used.

### Example 7

An amino group-containing organosilicon compound having the formula (12) and having a chlorine atom content of less than 0.1 ppm by weight was produced in the same manner as in Example 1 except that in place of KYOWAAD 100, the same part by weight of KYOWAAD 2000 was used.

### (2) Production of Amino Group-Containing Organosilicon Compound (8)

### Example 8

(EtO)₃—Si—C₃H₆—NH₂ (8)

In a 1 L separable flask equipped with a stirrer, a reflux condenser, a dropping funnel, and a thermometer, 1000.0 g of 3-aminopropyltriethoxysilane and 1.0 g of KYOWAAD 100 (manufactured by Kyowa Chemical Industry Co., Ltd., the same applies hereinafter) were put and stirred at room temperature for 6 hours under a nitrogen atmosphere. From the resulting solution, KYOWAAD 100 was removed by pressure filtration, and the obtained solution was purified by distillation under the conditions of 10 Torr and 90° C. to obtain 900 g of an amino group-containing organosilicon compound (8) as a colorless transparent liquid. The obtained colorless transparent liquid had a chlorine atom content of less than 0.1 ppm by weight.

### Example 9

An amino group-containing organosilicon compound having the formula (8) and having a chlorine atom content of less than 0.1 ppm by weight was produced in the same manner as in Example 8 except that in place of KYOWAAD 100, the same part by weight of KYOWAAD 200 was used.

### Example 10

An amino group-containing organosilicon compound having the formula (8) and having a chlorine atom content of less than 0.1 ppm by weight was produced in the same manner as in Example 8 except that in place of KYOWAAD 100, the same part by weight of KYOWAAD 300 was used.

### Example 11

An amino group-containing organosilicon compound having the formula (8) and having a chlorine atom content of less than 0.1 ppm by weight was produced in the same manner as in Example 8 except that in place of KYOWAAD 100, the same part by weight of KYOWAAD 500 was used.

### Example 12

An amino group-containing organosilicon compound having the formula (8) and having a chlorine atom content of less than 0.1 ppm by weight was produced in the same manner as in Example 8 except that in place of KYOWAAD 100, the same part by weight of KYOWAAD 600 was used.

### Example 13

An amino group-containing organosilicon compound having the formula (8) and having a chlorine atom content of less than 0.1 ppm by weight was produced in the same manner as in Example 8 except that in place of KYOWAAD 100, the same part by weight of KYOWAAD 700 was used.

### Example 14

An amino group-containing organosilicon compound having the formula (8) and having a chlorine atom content of less than 0.1 ppm by weight was produced in the same manner as in Example 8 except that in place of KYOWAAD 100, the same part by weight of KYOWAAD 2000 was used.

### [2] Production of Organosilicon Compound Having Ketimine Structure

### (1) Production of Organosilicon Compound (13) Having Ketimine Structure

### Example 15

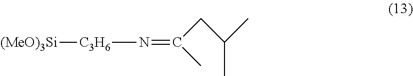

In a 5 L separable flask equipped with a stirrer, a reflux condenser, a dropping funnel, and a thermometer, 2028 g (18.4 mol) of methyl isobutyl ketone was put, 540 g (3.01 mol) of the organosilicon compound obtained in Example 1 was added dropwise at an internal temperature of 105 to 110° C. over 1 hour, and then the resulting mixture was stirred at 115° C. for 6 hours. During the dropwise addition and during the aging, generated water was refluxed with methyl isobutyl ketone and thus withdrawn. As a result of analysis with a gas chromatograph, the peak of 3-aminopropyltrimethoxysilane was disappeared, and 1680 g of a pale yellow transparent liquid was obtained after the aging.

The obtained solution was purified by distillation under the conditions of 10 Torr and 160° C. to obtain 690 g of a colorless transparent liquid. The colorless transparent liquid was determined to be an organosilicon compound having the formula (13) by ¹H-NMR.

### Example 16

An organosilicon compound having the formula (13) was produced in the same manner as in Example 15 except that in place of the organosilicon compound obtained in Example 1, the same parts by weight of the organosilicon compound obtained in Example 2 was used.

### Example 17

An organosilicon compound having the formula (13) was produced in the same manner as in Example 15 except that in place of the organosilicon compound obtained in Example 1, the same parts by weight of the organosilicon compound obtained in Example 3 was used.

### Example 18

An organosilicon compound having the formula (13) was produced in the same manner as in Example 15 except that in place of the organosilicon compound obtained in Example 1, the same parts by weight of the organosilicon compound obtained in Example 4 was used.

### Example 19

An organosilicon compound having the formula (13) was produced in the same manner as in Example 15 except that in place of the organosilicon compound obtained in Example 1, the same parts by weight of the organosilicon compound obtained in Example 5 was used.

### Example 20

An organosilicon compound having the formula (13) was produced in the same manner as in Example 15 except that in place of the organosilicon compound obtained in Example 1, the same parts by weight of the organosilicon compound obtained in Example 6 was used.

### Example 21

An organosilicon compound having the formula (13) was produced in the same manner as in Example 15 except that in place of the organosilicon compound obtained in Example 1, the same parts by weight of the organosilicon compound obtained in Example 7 was used.

### Comparative Example 1

An organosilicon compound having the formula (13) was produced in the same manner as in Example 15 except that in place of the organosilicon compound obtained in Example 1, the same parts by weight of 3-aminopropyltrimethoxysilane having a chlorine atom content of 0.1 ppm by weight or more was used.
(2) Production of Organosilicon Compound (7) Having Ketimine Structure

### Example 22

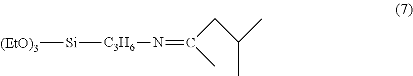

In a 5 L separable flask equipped with a stirrer, a reflux condenser, a dropping funnel, and a thermometer, 2,028 g (18.4 mol) of methyl isobutyl ketone was put, 667 g (3.01 mol) of the organosilicon compound obtained in Example 8 was added dropwise at an internal temperature of 105 to 110° C. over 1 hour, and then the resulting mixture was stirred at 115° C. for 6 hours. During the dropwise addition and during the aging, generated water was refluxed with methyl isobutyl ketone and thus withdrawn. As a result of analysis with a gas chromatograph, the peak of 3-aminopropyltriethoxysilane was disappeared, and 2,050 g of a pale yellow transparent liquid was obtained after the aging.

The obtained solution was purified by distillation under the conditions of 10 Torr and 170° C. to obtain 795 g of a colorless transparent liquid. The colorless transparent liquid was determined to be an organosilicon compound having the formula (7) by ¹H-NMR.

### Example 23

An organosilicon compound having the formula (7) was produced in the same manner as in Example 22 except that in place of the organosilicon compound obtained in Example 8, the same parts by weight of the organosilicon compound obtained in Example 9 was used.

### Example 24

An organosilicon compound having the formula (7) was produced in the same manner as in Example 22 except that in place of the organosilicon compound obtained in Example 8, the same parts by weight of the organosilicon compound obtained in Example 10 was used.

### Example 25

An organosilicon compound having the formula (7) was produced in the same manner as in Example 22 except that in place of the organosilicon compound obtained in Example 8, the same parts by weight of the organosilicon compound obtained in Example 11 was used.

### Example 26

An organosilicon compound having the formula (7) was produced in the same manner as in Example 22 except that in place of the organosilicon compound obtained in Example 8, the same parts by weight of the organosilicon compound obtained in Example 12 was used.

### Example 27

An organosilicon compound having the formula (7) was produced in the same manner as in Example 22 except that in place of the organosilicon compound obtained in Example 8, the same parts by weight of the organosilicon compound obtained in Example 13 was used.

### Example 28

An organosilicon compound having the formula (7) was produced in the same manner as in Example 22 except that in place of the organosilicon compound obtained in Example 8, the same parts by weight of the organosilicon compound obtained in Example 14 was used.

### Comparative Example 2

An organosilicon compound having the formula (7) was produced in the same manner as in Example 22 except that in place of the organosilicon compound obtained in Example 8, the same parts by weight of 3-aminopropyltriethoxysilane having a chlorine atom content of 0.1 ppm by weight or more was used.

The organosilicon compound having a ketimine structure obtained in each of Examples and Comparative Examples described above was filled in a closed container and stored at 25° C. The purity immediately after the purification by distillation and the purity after 12 months were measured using a gas chromatograph under the following conditions. Table 1 shows the results.

### Measurement of Purity

Gas chromatograph: HP 7890B manufactured by Agilent Technologies, Inc.
Detector: thermal conductivity detector (TCD)
Column: DB-5 (length 30 m×inner diameter 0.530 mm×film thickness 1.50 μm)
Column temperature: 100° C.→temperature rising 15° C./min→300° C. (holding for 10 minutes)
Measurement time: 23.3 minutes in total
Inlet temperature: 250° C.
Detector temperature: 300° C.

### Carrier gas: He

Carrier gas flow rate: 3.0 mL/min

TABLE 1

| | | | Amino group-containing | | | | |
|---|---|---|---|---|---|---|---|
| | | Organosilicon | organosilicon compound | | | Purity (%) | |
| | | compound | | | Chlorine | Immediately | |
| | | having | | | atom | after | |
| | | ketimine | | Used | content | purification | After |
| | | structure | Example | KYOWAAD | (ppm) | by distillation | 12 months |
| Example | 15 | (13) | Example 1 | 100 | <0.1 | 99.4 | 99.1 |
| | 16 | (13) | Example 2 | 200 | <0.1 | 99.1 | 98.6 |
| | 17 | (13) | Example 3 | 300 | <0.1 | 99.2 | 98.6 |
| | 18 | (13) | Example 4 | 500 | <0.1 | 99.2 | 99.0 |
| | 19 | (13) | Example 5 | 600 | <0.1 | 99.3 | 89.8 |
| | 20 | (13) | Example 6 | 700 | <0.1 | 99.5 | 99.0 |
| | 21 | (13) | Example 7 | 2000 | <0.1 | 99.2 | 98.6 |
| Comparative | 1 | (13) | — | — | 0.2 | 98.9 | 93.2 |
| Example | | | | | | | |
| Example | 22 | (7) | Example 8 | 100 | <0.1 | 99.5 | 99.0 |
| | 23 | (7) | Example 9 | 200 | <0.1 | 99.4 | 99.1 |
| | 24 | (7) | Example 10 | 300 | <0.1 | 99.4 | 98.9 |
| | 25 | (7) | Example 11 | 500 | <0.1 | 99.1 | 98.9 |
| | 26 | (7) | Example 12 | 600 | <0.1 | 99.4 | 98.8 |
| | 27 | (7) | Example 13 | 700 | <0.1 | 99.7 | 99.0 |
| | 28 | (7) | Example 14 | 2000 | <0.1 | 99.2 | 98.7 |
| Comparative | 2 | (7) | — | — | 0.3 | 99.1 | 95.1 |
| Example | | | | | | | |

As shown in Table 1, it is found that the organosilicon compounds having a ketimine structure obtained in Examples 15 to 28 show a slight decrease in purity after the long-term storage, and have high storage stability.

As described above, according to the method for producing of the present invention, an organosilicon compound having a ketimine structure and excellent in storage stability can be obtained even if a relatively small amount of an inorganic adsorbent is used.

Japanese Patent Application No. 2021-128006 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A method for producing an organosilicon compound having a ketimine structure, the organosilicon compound having the formula (1) described below: 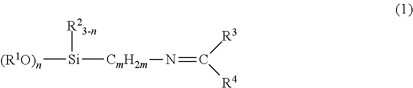
wherein each R¹ independently represents an alkyl group having 1 to 10 carbon atoms or an aryl group having 6 to 10 carbon atoms,
each R² independently represents an alkyl group having 1 to 10 carbon atoms or an aryl group having 6 to 10 carbon atoms,
R³ and R⁴ each independently represent a hydrogen atom, an alkyl group having 1 to 10 carbon atoms, or an aryl group having 6 to 10 carbon atoms,
n represents an integer of 1 to 3, and m represents an integer of 1 to 12,
the method comprising a step of reacting an amino group-containing organosilicon compound having the formula (2) described below and having a chlorine atom content of less than 0.1 ppm by weight with a carbonyl compound having the formula (3) described below: 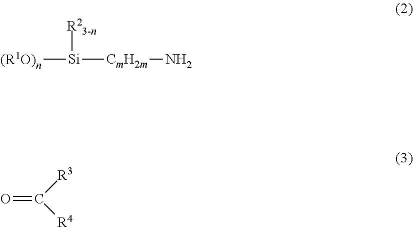
wherein R¹, R², R³, R⁴, n, and m are as described above.

2. The method for producing an organosilicon compound having a ketimine structure according to claim 1, wherein R¹ is a methyl group or an ethyl group, R³ is an isobutyl group, R⁴ is a methyl group, and m and n are 3.

3. The method for producing an organosilicon compound having a ketimine structure according to claim 1, comprising a step of reducing a chlorine atom content of the amino group-containing organosilicon compound having the formula (2) to less than 0.1 ppm by weight using an inorganic adsorbent.

4. A method for producing an amino group-containing organosilicon compound, the amino group-containing organosilicon compound having the formula (2) described below: 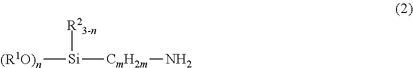
wherein each R¹ independently represents an alkyl group having 1 to 10 carbon atoms or an aryl group having 6 to 10 carbon atoms,
each R² independently represents an alkyl group having 1 to 10 carbon atoms or an aryl group having 6 to 10 carbon atoms,
n represents an integer of 1 to 3, and m represents an integer of 1 to 12,
the method comprising a step of reducing a chlorine atom content to less than 0.1 ppm by weight using an inorganic adsorbent.

5. The method for producing an amino group-containing organosilicon compound according to claim 4, wherein the inorganic adsorbent is one or more selected from silica, aluminum hydroxide, hydrotalcite, magnesium silicate, aluminum silicate, aluminum oxide, and magnesium oxide.
